(19) United States
(12) Patent Application Publication
(10) Pub. No.: US 2023/0379529 A1
(43) Pub. Date: Nov. 23, 2023

(54) DISTRIBUTED MEDIA STREAM PLAYBACK SUSPENSION AND SYNCHRONIZATION

(71) Applicant: Microsoft Technology Licensing, LLC, Redmond, WA (US)

(72) Inventors: Steven W. Ickman, Snoqualmie, WA (US); Ryan Jeffrey BLISS, Seattle, WA (US); Siddharth UPPAL, Bothell, WA (US); Hal Raphael BOND, Seattle, WA (US); Pradeep ANANTHARAMAN, Redmond, WA (US)

(21) Appl. No.: 18/198,004

(22) Filed: May 16, 2023

Related U.S. Application Data
(60) Provisional application No. 63/343,518, filed on May 18, 2022.
(60) Provisional application No. 63/344,865, filed on May 23, 2022.

(51) Int. Cl. H04N 21/43

(52) U.S. Cl. CPC H04N 21/43076

(57) ABSTRACT

A computer implemented method controls a first device to coordinate with other devices in suspending playback of a media stream that is accessed and played by each device. A first wait point identifies a first playback position and is associated with a first action. Upon encountering the first playback position, playback of the first media stream is suspended. Upon detection of completion of the first action by the first device, the suspension is ended and an update message representing a ready to resume state is broadcast to other devices that are playing respective media streams. Playback is resumed by the first device in response to receiving a threshold number of the update messages from the other devices.

### RELATED APPLICATIONS

This application claims priority to U.S. Provisional Application Ser. No. 63/343,518 (entitled LIVE SHARING, CO-WATCHING AND VIDEO SYNCHRONIZATION, filed May 18, 2022) which is incorporated herein by reference and claims priority to U.S. Provisional Application Ser. No. 63/344,865 (entitled LIVE SHARING, CO-WATCHING AND VIDEO SYNCHRONIZATION, filed May 18, 2022) which is incorporated herein by reference.

### TECHNICAL FIELD

Embodiments pertain to distributed media stream playback suspension and synchronization for multiple devices. Some embodiments pertain to synchronizing device clocks in an efficient manner and utilizing status updates to synchronize devices to complete actions and resume playback once a selected number of devices are ready to resume playback.

### BACKGROUND

Unified communications platforms such as MICROSOFT® TEAMS® provide users with the ability to collaborate remotely with other users by sharing content such as audio and video; participating in network-based meetings; chatting with other users; posting messages to other users; and the like. Such platforms generally share a screen of a device of one user with the other users to allow all users to view information being displayed on the user's device screen. The platforms and associated applications help keep content coordinated across chat and meeting sessions and add flexibility to separate permissions for individual collaborative features, such as chat and meeting sessions, depending on user roles in those sessions.

Many different user devices have different types of displays and connectivity and may be attached to networks that can support higher or lower data rates than those of the user's device that is sharing their screen. Screen sharing allows shared content to be synchronized, bandwidth permitting, however, the capabilities of such devices may not be fully utilized, leaving their users with sub-optimal views of the information.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a block diagram of a system that includes multiple client devices that operate to synchronize content according to some examples of the present disclosure.

FIG. 2 is a flowchart representing a computer implemented method 200 of synchronizing clocks of multiple client devices according to some examples of the present disclosure.

FIG. 3 is a flowchart representation of a computer implemented method 300 of synchronizing state replication for all the synchronization objects accessed by and for playback on client devices according to some examples of the present disclosure.

FIG. 4 is a block diagram illustrating example information for an update message according to some examples of the present disclosure.

FIGS. 5A and 5B are pseudocode representations of multiple export interfaces used to communicate update message in the form of synchronization event objects according to some examples of the present disclosure.

FIGS. 6A and 6B illustrate further export interfaces for providing further information regarding the playback session according to some examples of the present disclosure.

FIG. 7 is a block diagram of an example client device according to some examples of the present disclosure.

FIG. 8 is a flowchart of a computer implemented method for synchronizing a content state on a device with a content state of multiple other devices according to some examples of the present disclosure.

FIG. 9 is a flowchart of a computer implemented method for synchronizing a clock of the device with clocks of multiple other devices according to some examples of the present disclosure.

FIG. 10 is a flowchart of a computer implemented method for synchronizing a clock of the device with clocks of multiple other devices according to some examples of the present disclosure.

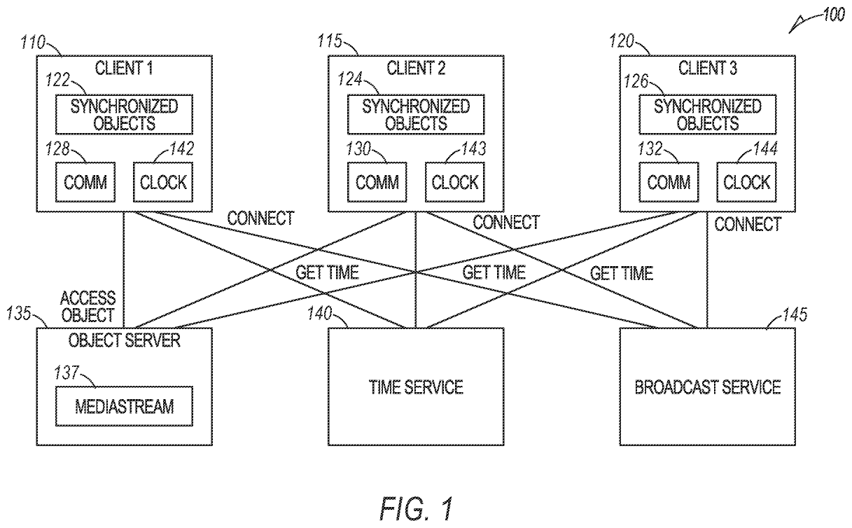

FIG. 1 is a flowchart illustrating a computer implemented method for controlling a first device to coordinate with other devices in suspending playback of a media stream according to some examples of the present disclosure.

FIG. 12 is a block diagram illustrating an example of a machine upon which one or more embodiments may be implemented according to some examples of the present disclosure.

FIG. 13 illustrates an example unified communication system according to some examples of the present disclosure.

### DETAILED DESCRIPTION

Users of client devices that are each independently accessing and viewing content, such as streaming media, may desire that each client device be synchronized such that all users are viewing the same content at any particular point in time. This may be useful during a virtual meeting involving client devices having different capabilities. As each client device is accessing the content for playback, ensuring all client devices are playing back the content at the same place in the content at the same time is a technical problem. The clocks on each client device may not be synchronized, resulting in a further technical problem of determining what each client device is playing back at any point in time.

In one example, a technical solution includes each client device synchronizing their clock to a reference time, such as a time server. In one example, each client device may send a request to a time server to obtain the time. The client device tracks the amount of time elapsed between sending the request and receiving the time. About one-half of the time elapsed is added to the time that is received and is used to set the clock of the client device. In one example, several such time requests may be made until the time elapsed is no longer decreasing. A most likely time elapsed, which may be the shortest time elapsed or a median time elapsed, may be used in setting the client device clock.

Many of the client devices may be further away from the time server and include different network delays as well as different browsers that may also have queues which can result in delay of receiving update messages. By using an offset of about one-half of the delay give or take 10% or so, each clock should be set to a synchronized time within 5-10 ms that enables synchronization of playback of content within a few frames, such as one to three frames given content playback rates of 30 frames per second. While not the most accurate, the synchronization consumes few computing resources while providing adequate clock synchronization for content playback such as streaming media or video.

Each client device may make their own connection to a media service to obtain and stream or play the content. By independently accessing and playing the content, such as video, each device can take advantage of the device and network capabilities. This allows users or participants in a meeting or collaboration to obtain the best video quality for their device capabilities and network connection rather than being potentially bottlenecked by the sharing user's device capabilities and bandwidth. The video may also be optimized for the device, and may have closed captioning or other options. In one example, a participant, such as the participant that launched the video may control the playback simply by controlling the playback on their client device.

As each client device plays back the content, the client devices may send update messages that include an update message sent timestamp and a state of the content being played on the client device. Upon receiving update messages a client device may determine a most recent update message based on the update message sent timestamps regardless of the order such update messages were received or sent. This technical solution allows each client device to identify the most current content state of the content from the most recent update message, and set their playback state to the same state. As further client devices join a session, meeting, or other group of users collaboratively viewing the content, the update messages may be used to quickly synchronize joining client devices to the most recent state of playback.

In some examples, media synchronization may be performed using a leaderless peer-to-peer synchronization protocol capable of synchronizing the playback of media across multiple clients with sub-second precision. The leaderless aspect of the algorithm means that there is no one central client that maintains the truth for the state of the session. Client devices can join and leave the session at will and the overall state of the session will be maintained so long as at least one client device is still part of the session.

In some examples, devices perform content or video synchronization to enable users to synchronize video watching amongst members of a group of users. Both local and remote users may interact with other applications during a network-based meeting. In some examples, a unified communication platform may provide an application programming interface (API) that allows developers to embed collaboration features of a unified communication application directly into their apps.

FIG. 1 is a block diagram of a system 100 that includes multiple client devices 110, 115, and 120 labeled client 1, client 2, and client 3 respectively. Two or more client devices may be included in further examples. The client devices may respectively include one or more synchronized objects 122, 124, 126 that are accessed via communication modules 128, 130, 132 coupling to an object server 135 which may be referred to as a media streaming device having one or more media streams 137. Media streams from the object server may be accessed and sent or transported to client devices in accordance with one or more transport protocols.

A time service 140 may also be accessed via communication modules 128, 130, 132 to receive communications including an accurate time for use in setting the device clocks 142, 143, 144. A broadcast service 145, such as a relay or switch device, may be used to broadcast update messages received from one client device to the other of the multiple client devices. The update messages include an update message sent timestamp that represents the time that the update message was sent, and a state of the content being played on the client device.

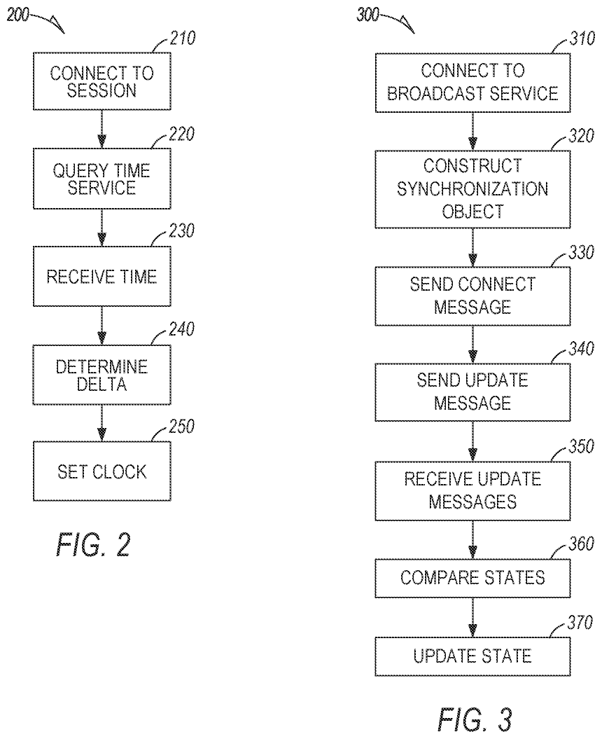

FIG. 2 is a flowchart representing a computer implemented method 200 of synchronizing clocks of multiple client devices. To ensure all the clients within a session agree on what the current time is, method 200 may utilize a central global time service, such as time service 140, to synchronize time for all clients in a session.

Method 200 begins in response to a client first connecting to a session at operation 210. In one example, the session may be hosted by broadcast service 145, which may be a unified communications platform. At operation 220, the client queries the time service for its current timestamp, using for example a getNtpTime request. The duration from the getNtpTime request to the receipt of a response including the timestamp is measured at operation 230. At operation 240, one-half of the request's duration is added to the timestamp returned by the time service to determine a delta between the receipt of the response and the time service clock. This process is then repeated several times to improve the accuracy of the timestamp returned from the time service. In one example, requests are repeated until request durations stop improving. An average of the durations of the last few requests may be used as the duration. Shorter request times generally result in improved accuracy.

The delta between the local machine clock and the time service clock is then calculated and is either used to reset the local machine clock at operation 250 or is added to the timestamp of all outgoing messages. In practice, request times of 60 ms on average are typical which means approximately 30 ms is typically added to the timestamp returned from the time service. That means that the clock for all clients within a session have at most an approximately 30 ms drift with one another. If every client's request to the time service were perfectly symmetrical, one would see about 0 ms drift between clients but due to factors like request queuing and such, the time requests are rarely symmetrical so there will always be some amount of drift between clients. If one could accurately measure the drift, one would likely see that its typically <10 ms.

Any drift between client clocks can be considered noise but it may limit just how tightly time-based things may be synchronized, like the playback of media, so it's worth recognizing that a small amount of clock drift may always exist.

FIG. 3 is a flowchart representation of a computer implemented method 300 of synchronizing state replication for playback on client devices. Synchronization state may be identified in a meeting notice or other communication, such as an email, or in a chat during a meeting between multiple client devices. Method 300 begins with one or more client devices first connecting to the broadcast service at operation 310. The client devices then construct their update messages at operation 320 and notify all other clients that they're connected by sending a “connect” message at operation 330. The connect message is sent to the broadcast service and then broadcast out to all other connected clients.

Client devices respond to this “connect” message at operation 340 by sending their current state via an “update” message. The state in one example is a playback state, and can include a playback location or a playback command as well as information identifying the client device and media being played. As client devices receive numerous update messages at operation 350 each client device compares the state in received update message using a conflict resolution algorithm at operation 360 to select the most recent in time update message. If a client device determines that the received state is newer at operation 370 based on the update message timestamp, the client device will update their internal state to match the received state. For the client device that just connected this results in the client device quickly syncing to the current state of the group.

The state of all client devices starts off in an initial empty state so in the case where there's only a single client device, the object's state will just stay empty until the user initiates some state change. Then as other client devices join the session, the other client devices will start off in an empty state but quickly transition to the initial user's current state based on the update messages.

A message from one client device that was sent before a message from a second client device can arrive after the message from the second client device. The broadcaster may queue outgoing messages so should the client device lose its socket connection, any queued messages will be delayed until after the socket connection is re-established. Even for messages from the same client device there's no guarantee they'll arrive in the order they were sent. Messages should generally arrive in the order they're sent but because of the multi-threaded nature of the broadcast service, there are no guarantees. The client device could crash before it has flushed its queue. The broadcast service could crash. Any number of things could result in a message getting dropped before it makes it to the receiving client device.

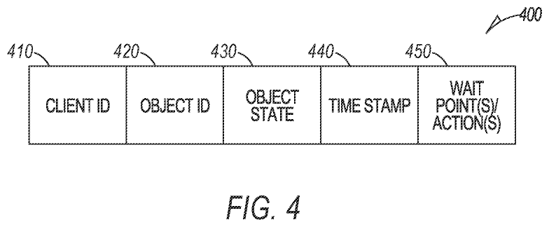

FIG. 4 is a block diagram illustrating example information for an update message 400. The generation of update messages resolves the first two issues by encoding the update message 400 with a unique client ID 410 of the client device sending the update message 400. The update message 400 may also include an object ID 420 that identifies a media stream being played back, and object state 430 that identifies a state of the object, and a timestamp 440 of when the message was sent.

Receivers can then compare the timestamp of the received update message with the time stamp of latest message they've seen. If the timestamp of the newest received update message is newer, they know the message is a newer message that should be processed to set the media stream state to the state indicated. If the timestamp is older, the update message can simply be ignored. Should the received messages timestamp match the previously seen messages timestamp, the client device ID's of the two messages will be used as a tie breaker. The client device IDs are compared for sort order and the client device ID with the lowest sort order wins.

To deal with the case where messages might not arrive at all, each client device periodically re-broadcasts an update message with their latest state information. In one example, the interval may be 5, 10, or 15 seconds or more. The interval or latency determines how long a client device could have to wait to recover from missing a message. The more client devices in the session the more frequently these updates may be sent as the odds are more likely that a client device will have been added to a session or have missed a message.

In one example, the update messages are video transport control messages are sent by client devices anytime the track is changed, played, paused, or seeked and the same conflict resolution algorithm is used to deal with transport operations that come in late or out of order. To protect against missed messages, client devices send periodic “update” messages containing the entirety of the current transport state of the video from the client device's perspective. These update messages are then processed as if they were transport operation message, and the method 300 takes care of ignoring any older or duplicate transport state messages.

To help achieve ultra-tight playback synchronization, every transport operation may include both the timestamp of when the client device performed the transport operation and the position of the playback at that point in time. Since the clocks of all client devices can be assumed to be within a few milliseconds of each other, the receiving client device can compare the timestamp of when the transport operation occurred with the current timestamp to determine, within ˜10 ms, how long ago the operation occurred. For transport operations like “play”, this network delay can be added to the messages playback position to determine an estimate of the sender's current playback position within the media. That estimated position then becomes the goal post that all client devices try to stay in sync with. In one example, the client devices may agree to delay implementation of a transport operation based on estimated communication delay added to the timestamp. Such delay would enable all client devices to start playback at the same synchronized time as opposed to the device sending the latest transport operation starting at the time the transport operation was sent and also can account for various network delays in delivering the transport operation to other client devices.

In various client devices, content buffering and other processing with players and a host application may make it difficult to stay in perfect sync. Too much re-syncing can result in a jittery end user experience. Various levels of tightness of synchronization may be used in different example implementations. In some examples, keeping client devices within 4-8 video frames of each other is obtainable on various networks. When the playback is paused, the object state 430 may be used to sync all client devices to an exact frame.

Update message 400 may also include one or more wait points 450. Each of the wait points 450 is a predefined point in a media stream where all client devices suspend playback and wait before continuing. The wait points 450 can be defined either statically when the track is loaded or dynamically during playback and inserted into an update message 400. In one example, a static wait point at the beginning of a video can be assigned to have all client devices wait for the video to finish loading before proceeding, or at any point or at the end of a video to prompt the user to take a quiz before proceeding. Developers can dynamically assign them during a video to show an ad to a user and all client devices will wait until the ad is completed. The one or more wait points 450 may include one or more associated actions to be performed in response to reaching the wait point while playing the media stream. The actions may be specified as objects to be accessed and instantiated to execute.

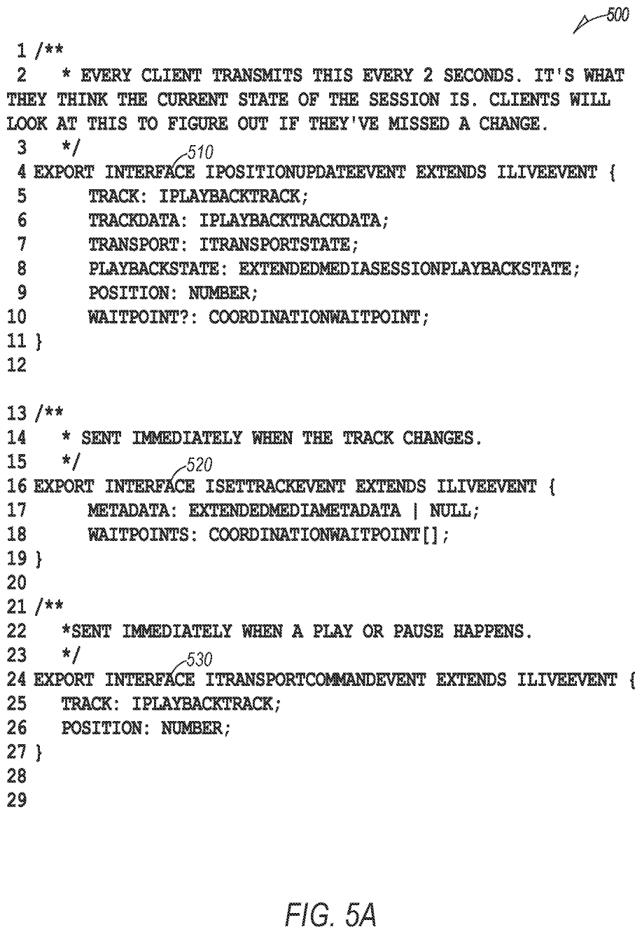

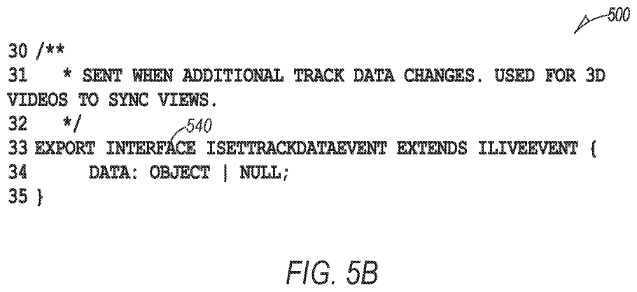

FIGS. 5A and 5B are pseudocode representations of multiple export interfaces used to communicate update message in the form of synchronization event objects indicated generally at 500. A first export interface 510 is used periodically transmit data representative of the current state of playback in a session involving multiple devices. In one example, the data is transmitted very two seconds, but may be transmitted more frequently or less frequently in further examples. The data sent via first export interface 510 includes an identification of an event (IPositionUpdateEvent) and an indication that the event is currently active (ILiveEvent). Further information identifies the exact state of playback of a media object by track, trackData, transport state, playback state, position, and an optional waitpoint.

Export interface 520 is sent immediately when a track changes and includes metadata and waitPoints if any.

Export interface 530 is sent immediately when a play or pause happens, and identifies the location of the pause via a track and position within the track.

Export interface 540 is sent when additional track data changes and may be used for three-dimensional videos to synchronize views of a three-dimensional object.

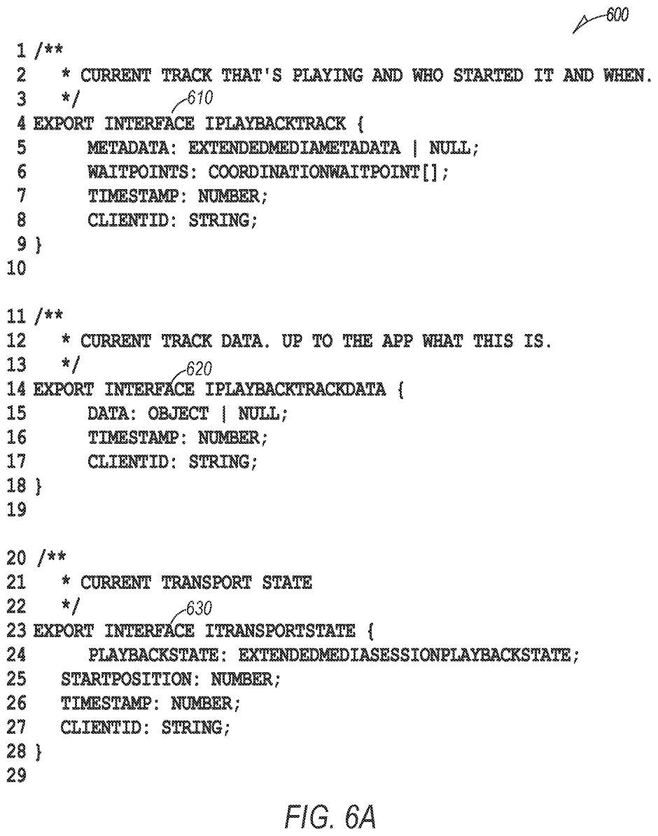

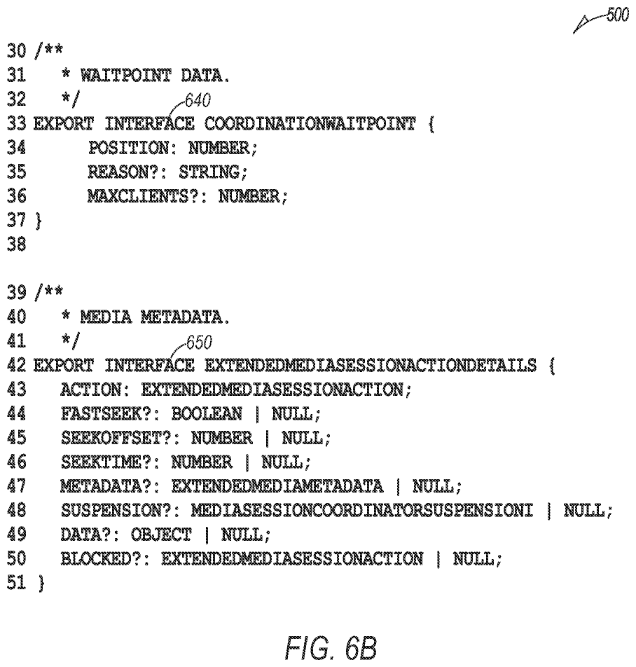

FIGS. 6A and 6B illustrate further export interfaces for providing further information regarding the playback session generally at 600. Export interface 610 is used to identify a current track that is playing, which client device started the track, and when the track was started. This is done by providing metadata, wait points, timestamp that identifies the start time of the track, and clientID information. Actions may be identified in the metadata.

Export interface 620 is used to provide current track data for use by an application in providing additional functions or for auditing purposes. Each application may use this data differently, such as triggering playback controls or inserting further wait points which may be communicated via various export interfaces.

Export interface 630 is used to describe the current transport state, including playbackState, startPosition, timestamp, and clientId.

Export interface 640 may be used for providing wait point data and includes position, a reason, and a maxClients number used to identify how many client devices it takes to end their suspension after reaching the wait point, before each device will the resume playback.

Export interface 650 provide media metadata, which may include an action, fastSeek, seeOffset number, seekTime number, extended media metadata, a suspension, optional data, blocked information.

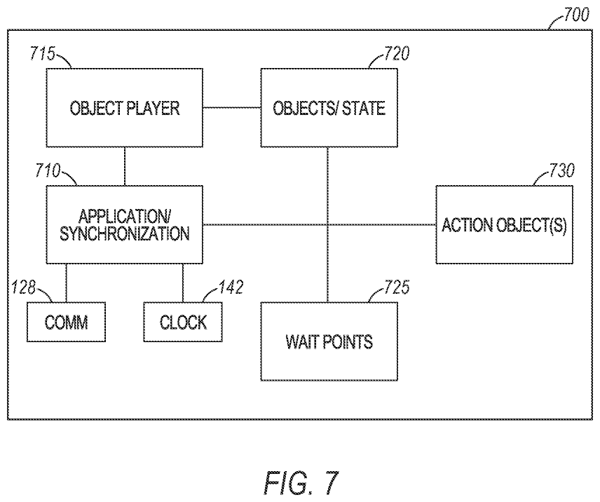

FIG. 7 is a block diagram of an example client device 700. In addition to the communication module 128 and clock 142 shown in client device 110 in FIG. 1, client device 700 includes an application 710, an object player 715, one or more objects 720 that may have an associated playback state, one or more wait points 725, and may also include one or more action objects 730 that are associated with wait points 725.

Application 710 is utilized to implement one or more methods to control playback of content in one or more of objects 720 and to generate and process update messages, including transport operations. The application 710 will insert the update message sent time stamp using a current time from the clock 142 and initiate sending of the message to other devices.

The state of objects 720 is set by application 710 in response to processing of the update messages as well as processing of the wait points 725. One or more objects may be playing back in one or more sessions in various examples, which each being synchronized via update messages.

Wait points are associated with specific playback position in the media stream and once the local client device hits that point in the media stream a local suspension is automatically triggered. The wait points 725 may each have an associated action object 730.

The local client device can then take whatever action is indicated by the associated action object 730. Once the action finishes, the local client device can end the suspension using a signal to the rest of the client devices, such as via an update message, that the client device is ready to proceed.

Normally when client device 700 initiates a suspension, the media or object player 715 will immediately resynchronize with the other client devices once the local suspension ends. Wait points differ in that once the wait points suspension ends, the client device signals to all of the other client devices that its ready and it's not until all the other client devices, or a set number of client devices are ready before each client device independently resynchronizes and resumes playback.

In one example, a client device may utilize a local suspension function that lets client devices temporarily disconnect from having their local player synchronizing with the rest of the group. The client device in a local suspension is basically ignoring other updates and not attempting the synchronize based on the updates until a user or other action cause ending of the local suspension.

In one example, a role verification function provides an added layer of security in semi-trusted environments like classrooms. A teacher might have all their students in a virtual meeting watching a video for an assignment. While all the students are trusted to be in the virtual meeting, role verification prevents update messages from the students from disturbing the video being played back. Role verification helps protect against scenarios like this by screening out any messages sent by users that don't have a specific meeting role. A student may be able to hack their client device, but the role verification logic running in all the other client devices would cause their bogus message to be ignored.

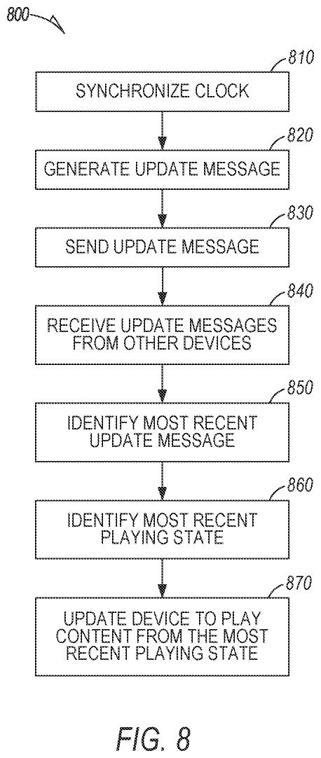

FIG. 8 is a flowchart of a computer implemented method 800 for synchronizing a content state on a device with a content state of multiple other devices. Method 800 beings at operation 810 by ensuring that a clock on the device is synchronized with clocks on each of the multiple other devices. This can be done by accessing a time service in one example or by ensuring that the clock is very accurate following initial synchronization to a trusted time reference.

Operation 820 generates an update message that includes an update message timestamp from the synchronized clock and a state of content being played on the device. The update messages are sent and received periodically, such as every 2 seconds in one example. In further examples, the update message may be sent in response to a ping from any of the other devices. The state of content included in the update message may include content track information and playback state information. In one example, an update message may include an export interface object that identifies a playback command performed on the content. The export interface object may alternatively identify a starting client device and starting time of the content.

The updated message is sent at operation 830 to the multiple other devices to share the state of content playback at the device. The update message may be sent using broadcast service 145 in one example. At operation 840, update messages that include an update message timestamp and state of content being played are received from the multiple other devices. Each received update message includes a playing state of content being played from a respective one of the other devices corresponding to the update message timestamp.

At operation 850, time stamps in the sent and received update messages are compared to identify a most recent update message. Since the timestamps are derived from synchronized clocks, the timestamps accurately represent the state of playback of the content at the time the update messages were generated. Operation 860 identifies the most recent playing state of the content from the most recent update message.

Operation 870 updates the local device to play the content from the most recent playing state included in the most recent update message. The update may be performed by an application that implements method 800 and interfaces with a playback application, such as a media streaming application that includes play, pause, and other common media streaming functions.

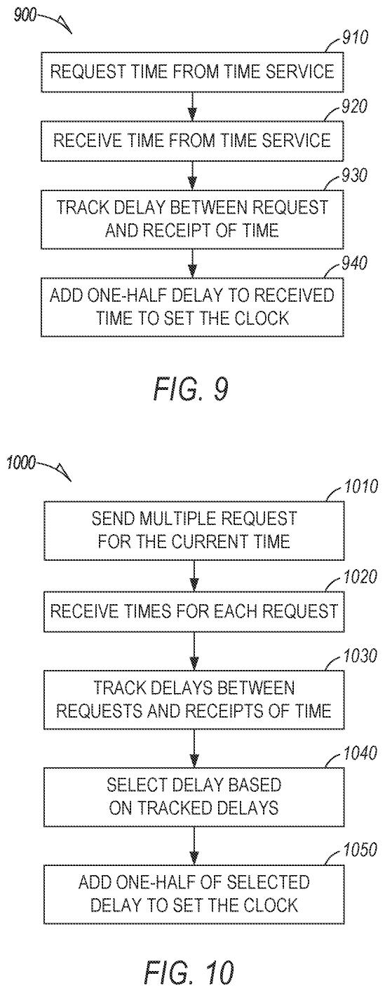

FIG. 9 is a flowchart of a computer implemented method 900 for synchronizing a clock of the device with clocks of multiple other devices. Method 900 beings at operation 910 by requesting a time from a time service. The time is received at operation 920. Operation 930 tracks a delay between requesting the time and receiving the time. About one-half the delay is added to the received time and used to set the clock of the device via operation 940. Method 900 provides a reasonably accurate synchronized time between all the devices for purposes of synchronizing media streaming without consuming significant processing and network resources to obtain a highly accurate synchronized time.

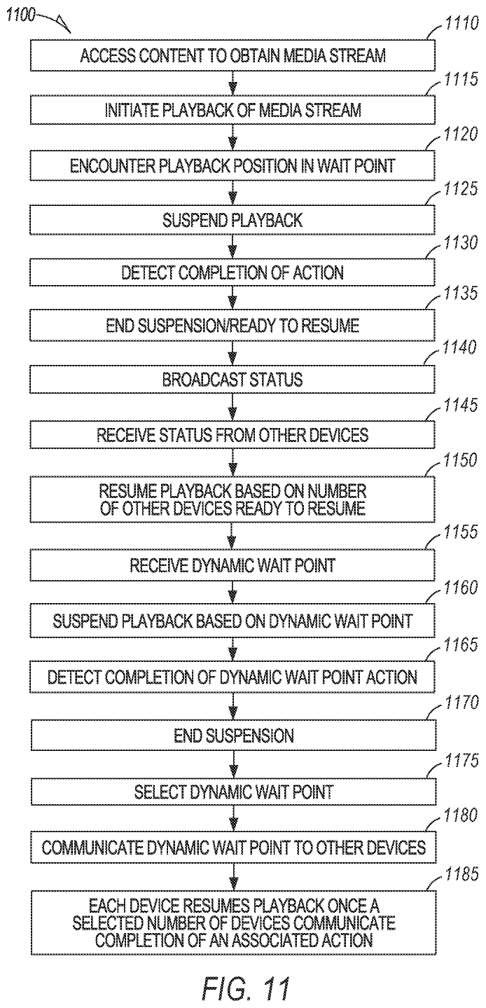

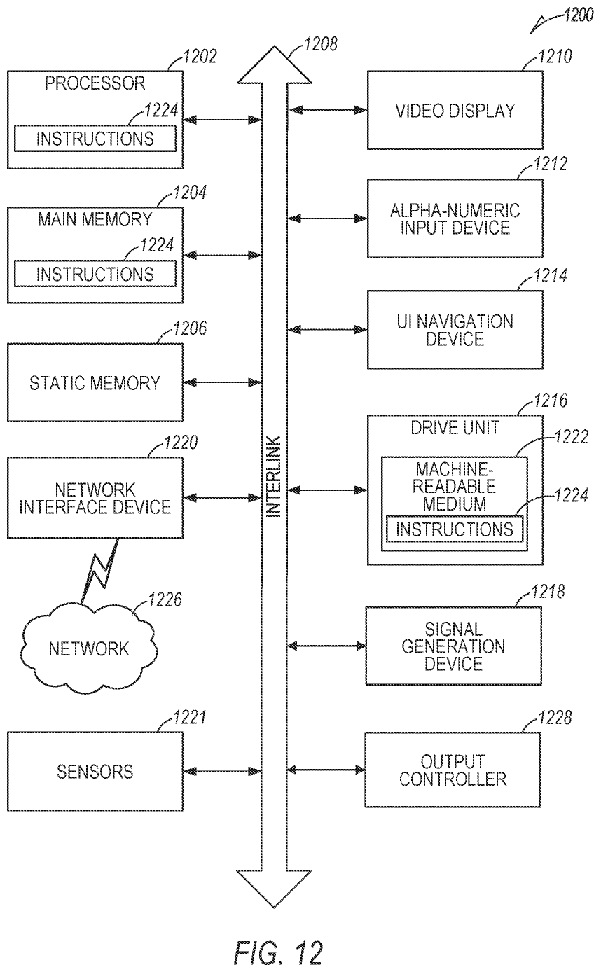

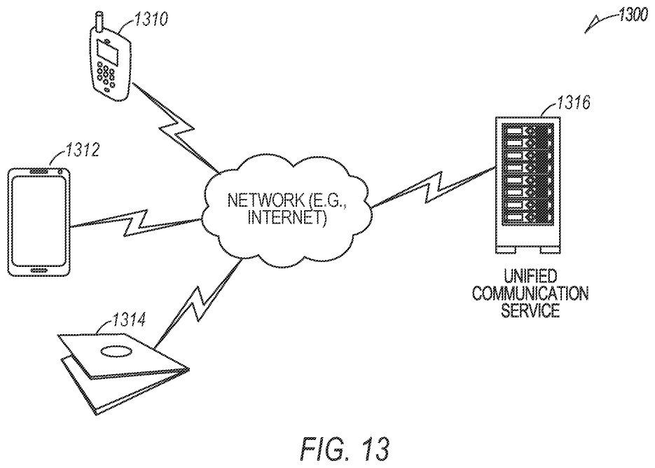

FIG. 10 is a flowchart of a computer implemented method 1000 for synchronizing a clock of the device with clocks of multiple other devices. Method 1000 beings at operation 1010 by sending multiple requests for a current time from a time service. At operation 1020, a time is received from the time service for each of the multiple requests. Operation 1030 includes tracking a delay between requesting the time and receiving the time for each of the multiple requests. Operation 1040 includes selecting a shortest delay from the tracked delays. Operation 1050 includes adding about one-half the shortest delay to the received time to set the clock.

FIG. 11 is a flowchart illustrating a computer implemented method 1100 for controlling a first device to coordinate with other devices in suspending playback of a media stream. Method 1100 begins at operation 1110 by accessing first content, via the first device to obtain a first media stream. The first media stream has an associated first wait point that identifies a first playback position in the first media stream and is also associated with a first action. Operation 1115 initiates playback of the media stream on the first device. The first playback position identified by the first wait point in the first media stream is encountered at operation 1120 following initiating of the playback. The first wait point and corresponding first playback position may be identified in a received status update generated either by the client device or another client device.

Operation 1125 suspends playback of the first media stream at the first playback position in response to encountering the first playback position identified by the first wait point. Operation 1130 detects completion by the first device of the first action associated with the first wait point. The status update may identify an action associated with the first wait point. The first action may include a poll related to the media stream and completion of the poll comprises completion of the first action. In a further example, the first action includes playback of a second media stream and completion of playback of the second media stream comprises completion of the first action.

Operation 1135 ends suspension of the playback of the media stream responsive to detection of the completion of the first action. Ending suspension results in the first device being in a state that is ready to resume playback of the first media stream. Operation 1140 includes broadcasting or otherwise communicating that the first device is ready to resume via a status update indicating that suspension has been ended. Operation 1145 includes receiving an indication that others of the multiple devices have ended suspension or are otherwise ready to resume. The indication may be multiple status updates received from multiple other client devices. In one example, a specified threshold number of received indications may be used to determine that the suspension should be ended. The threshold number may be equal to the number of client devices or less than the total number of client devices. For example, if there are 10 client devices in session, the threshold number may be any number greater than 1, or 10 or less. A more common threshold number may be 7, 8, or 9 of the 10. For session having fewer client devices, the threshold number may be equal to the number of client devices, such as 3, 4, or 5.

Operation 1150 includes resuming playback of the media stream in response to receiving the threshold number of status updates. Resuming playback of the media stream at operation 1150 in response to receiving the threshold number of status updates comprises resuming playback in response to a number of the others that have ended suspension reaching the threshold number of other devices.

In one example, the first device may locally suspend playback without regard to reaching the first playback position. To continue playback from a local suspension may be controlled by the application without regard to the first wait point or completion of the first action. Updates from other devices will be ignored until playback is resumed on the first device by ending the local suspension. While locally suspended, the first device may also refrain from sending update messages, or alternatively indicate that the first device is in a local suspension to at least confirm that the first device is still actively connected. Following ending the local suspension, the first device will receive and process the updates and synchronize accordingly.

Operation 1155 includes receiving a dynamic wait point following initiating playback of the media stream. A dynamic wait point is simply a wait point that is generated or received after initiation of the playback as opposed to being preconfigured. Operation 1160 includes suspending playback of the media stream in accordance with the second wait point. Operation 1165 includes detecting completion of a second action associated with the second wait point. Operation 1170 includes ending suspension of the playback of the media stream responsive to detection of the completion of the first action.

In one example, the first device may select an additional or dynamically set wait point at operation 1175 following initiating playback of the first media stream. Operation 1180 includes communicating the second wait point to the other devices via a status update. At operation 1185, each of the other devices resume playback of their respective media streams in response to received update messages.

FIG. 12 illustrates a block diagram of an example machine 1200 upon which any one or more of the techniques (e.g., methodologies) discussed herein may be performed. In alternative embodiments, the machine 1200 may operate as a standalone device or may be connected (e.g., networked) to other machines. In a networked deployment, the machine 1200 may operate in the capacity of a server machine, a client machine, or both in server-client network environments. In an example, the machine 1200 may act as a peer machine in peer-to-peer (P2P) (or other distributed) network environment. The machine 1200 may be in the form of a smartphone, personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on one or more logic units, components, or mechanisms (hereinafter “components”). Components are tangible entities (e.g., hardware) capable of performing specified operations and may be configured or arranged in a certain manner. In an example, circuits may be arranged (e.g., internally or with respect to external entities such as other circuits) in a specified manner as a component. In an example, the whole or part of one or more computer systems (e.g., a standalone, client or server computer system) or one or more hardware processors may be configured by firmware or software (e.g., instructions, an application portion, or an application) as a component that operates to perform specified operations. In an example, the software may reside on a machine readable medium. In an example, the software, when executed by the underlying hardware of the component, causes the hardware to perform the specified operations of the component.

Accordingly, the term “component” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which component are temporarily configured, each of the components need not be instantiated at any one moment in time. For example, where the components comprise a general-purpose hardware processor configured using software, the general-purpose hardware processor may be configured as respective different components at different times. Software may accordingly configure a hardware processor, for example, to constitute a particular module at one instance of time and to constitute a different component at a different instance of time.

Machine (e.g., computer system) 1200 may include one or more hardware processors, such as processor 1202. Processor 1202 may be a central processing unit (CPU), a graphics processing unit (GPU), a hardware processor core, or any combination thereof. Machine 1200 may include a main memory 1204 and a static memory 1206, some or all of which may communicate with each other via an interlink (e.g., bus) 1208. Examples of main memory 1204 may include Synchronous Dynamic Random-Access Memory (SDRAM), such as Double Data Rate memory, such as DDR4 or DDR5. Interlink 1208 may be one or more different types of interlinks such that one or more components may be connected using a first type of interlink and one or more components may be connected using a second type of interlink. Example interlinks may include a memory bus, a peripheral component interconnect (PCI), a peripheral component interconnect express (PCIe) bus, a universal serial bus (USB), or the like.

The machine 1200 may further include a display unit 1210, an alphanumeric input device 1212 (e.g., a keyboard), and a user interface (UI) navigation device 1214 (e.g., a mouse). In an example, the display unit 1210, input device 1212 and UI navigation device 1214 may be a touch screen display. The machine 1200 may additionally include a storage device (e.g., drive unit) 1216, a signal generation device 1218 (e.g., a speaker), a network interface device 1220, and one or more sensors 1221, such as a global positioning system (GPS) sensor, compass, accelerometer, or other sensor. The machine 1200 may include an output controller 1228, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 1216 may include a machine readable medium 1222 on which is stored one or more sets of data structures or instructions 1224 (e.g., software) embodying or utilized by any one or more of the techniques or functions described herein. The instructions 1224 may also reside, completely or at least partially, within the main memory 1204, within static memory 1206, or within the hardware processor 1202 during execution thereof by the machine 1200. In an example, one or any combination of the hardware processor 1202, the main memory 1204, the static memory 1206, or the storage device 1216 may constitute machine readable media.

While the machine readable medium 1222 is illustrated as a single medium, the term “machine readable medium” may include a single medium or multiple media (e.g., a centralized or distributed database, and/or associated caches and servers) configured to store the one or more instructions 1224.

The term “machine readable medium” may include any medium that is capable of storing, encoding, or carrying instructions for execution by the machine 1200 and that cause the machine 1200 to perform any one or more of the techniques of the present disclosure, or that is capable of storing, encoding or carrying data structures used by or associated with such instructions. The terms computer-readable medium, machine readable medium, memory device, and storage device do not include carrier waves or signals to the extent carrier waves and signals are deemed too transitory. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine readable media may include non-transitory machine readable media. In some examples, machine readable media may include machine readable media that is not a transitory propagating signal.

The instructions 1224 may further be transmitted or received over a communications network 1226 using a transmission medium via the network interface device 1220. The Machine 1200 may communicate with one or more other machines wired or wirelessly utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks such as an Institute of Electrical and Electronics Engineers (IEEE) 802.11 family of standards known as Wi-Fi®, an IEEE 802.15.4 family of standards, a 5G New Radio (NR) family of standards, a Long Term Evolution (LTE) family of standards, a Universal Mobile Telecommunications System (UMTS) family of standards, peer-to-peer (P2P) networks, among others. In an example, the network interface device 1220 may include one or more physical jacks (e.g., Ethernet, coaxial, or phone jacks) or one or more antennas to connect to the communications network 1226. In an example, the network interface device 1220 may include a plurality of antennas to wirelessly communicate using at least one of single-input multiple-output (SIMO), multiple-input multiple-output (MIMO), or multiple-input single-output (MISO) techniques. In some examples, the network interface device 1220 may wirelessly communicate using Multiple User MIMO techniques.

FIG. 13 illustrates a logical diagram of a unified communication system 1300 according to some examples of the present disclosure. Unified communication system 1300 may include one or more servers that perform functions of the object server 135, broadcast service 145 and timer service 140 in various examples.

User computing devices 1310, 1312, and 1314 may connect through a network (such as the Internet) to a unified communication service 1316. The unified communication service 1316 along with unified communication applications on the user computing devices 1310, 1312, and 1314 may provide unified communication services to the users of those devices such as voice, video, application sharing, video sharing, screen sharing, content sharing, network-based meetings, network-based calling, chats, and the like. In some examples, the unified communication application may be a dedicated unified communication application or may be a different type of application using a unified communication application API.

### EXAMPLES

1. A computer implemented method controls a first device to coordinate with other devices in suspending playback of a media stream. The method includes accessing first content, via the first device, to obtain a first media stream having a first wait point that identifies a first playback position in the first media stream and is associated with a first action, initiating playback of the first media stream on the first device, encountering the first playback position of the first media stream following initiating playback, suspending playback of the first media stream on the first device at the first playback position in response to encountering the first playback position identified by the first wait point, detecting completion of the first action by the first device, broadcasting an update message representing a ready to resume state by the first device to other devices that are accessing the first content and playing respective media streams of the first content, receiving update messages from the other devices representing one or more of the other devices have achieved ready to resume states, and resuming playback of the first media stream at the first device in response to receiving a threshold number of update messages indicating that the other devices have achieved the ready to resume states.

2. The method of example 1 and further including receiving a second wait point following initiating playback of the first media stream and suspending playback of the first media stream in accordance with the second wait point.

3. The method of example 2 and further including detecting completion of a second action associated with the second wait point and ending suspension of the playback of the first media stream responsive to detection of the completion of the first action.

4. The method of any of examples 1-3 and further including locally suspending playback by the first device.

5. The method of example 4 and further including refraining from sending update messages and ignoring update messages from other devices while the first device is locally suspended.

6. The method of example 5 and further including ending the local suspension and processing received update messages to update the playback and resume playback of the first media stream in accordance with the update messages.

7. The method of example 5 wherein the local suspension enables the first device to perform local playback operations without broadcasting update messages.

8. The method of any of examples 1-7 wherein the first wait point is pre-scheduled, identified in a received status update, and identifies a specific point in the first media stream.

9. The method of example 8 wherein the status update identifies the action associated with the first wait point.

10. The method of any of examples 1-8 and further including selecting a second wait point following initiating playback of the first media stream and communicating the second wait point to the other devices via a status update.

11. The method of any of examples 1-10 wherein each of the other devices resume playback of their respective media streams in response to received update messages.

12. A machine-readable storage device has instructions for execution by a processor of a machine to cause the processor to perform operations to perform any of the methods of examples 1-11.

13. A device includes a processor and a memory device coupled to the processor and having a program stored thereon for execution by the processor to perform operations to perform any of the methods of examples 1-11.

14. A method for video synchronization on a unified communication platform includes synchronizing streaming of a video from a video source to a plurality of participants of a network-based meeting provided by the unified communication platform.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

What is claimed is:

1. A computer implemented method for controlling a first device to coordinate with other devices in suspending playback of a media stream, the method comprising:
accessing first content, via the first device, to obtain a first media stream having a first wait point that identifies a first playback position in the first media stream and is associated with a first action;
initiating playback of the first media stream on the first device;
encountering the first playback position of the first media stream following initiating playback;
suspending playback of the first media stream on the first device at the first playback position in response to encountering the first playback position identified by the first wait point;
detecting completion of the first action by the first device;
broadcasting an update message representing a ready to resume state by the first device to other devices that are accessing the first content and playing respective media streams of the first content;
receiving update messages from the other devices representing one or more of the other devices have achieved ready to resume states; and
resuming playback of the first media stream at the first device in response to receiving a threshold number of update messages indicating that the other devices have achieved the ready to resume states.

2. The method of claim 1 and further comprising:
receiving a second wait point following initiating playback of the first media stream; and
suspending playback of the first media stream in accordance with the second wait point.

3. The method of claim 2 and further comprising:
detecting completion of a second action associated with the second wait point; and ending suspension of the playback of the first media stream responsive to detection of the completion of the first action.

4. The method of claim 1 and further comprising locally suspending playback by the first device.

5. The method of claim 4 and further comprising refraining from sending update messages and ignoring update messages from other devices while the first device is locally suspended.

6. The method of claim 5 and further comprising:
ending the local suspension; and
processing received update messages to update the playback and resume playback of the first media stream in accordance with the update messages.

7. The method of claim 5 wherein the local suspension enables the first device to perform local playback operations without broadcasting update messages.

8. The method of claim 1 wherein the first wait point is pre-scheduled, identified in a received status update, and identifies a specific point in the first media stream.

9. The method of claim 8 wherein the status update identifies the action associated with the first wait point.

10. The method of claim 1 and further comprising:
selecting a second wait point following initiating playback of the first media stream; and
communicating the second wait point to the other devices via a status update.

11. The method of claim 1 wherein each of the other devices resume playback of their respective media streams in response to received update messages.

12. A machine-readable storage device having instructions for execution by a processor of a machine to cause the processor to perform operations to perform a method for controlling a first device to coordinate with other devices in suspending playback of a media stream, the operations comprising:
accessing first content, via the first device, to obtain a first media stream having a first wait point that identifies a first playback position in the first media stream and is associated with a first action;
initiating playback of the first media stream on the first device;
encountering the first playback position of the first media stream following initiating playback;
suspending playback of the first media stream on the first device at the first playback position in response to encountering the first playback position identified by the first wait point;
detecting completion of the first action by the first device:
broadcasting an update message representing a ready to resume state by the first device to other devices that are accessing the first content and playing respective media streams of the first content;
receiving update messages from the other devices representing one or more of the other devices have achieved ready to resume states; and
resuming playback of the first media stream at the first device in response to receiving a threshold number of update messages indicating that the other devices have achieved the ready to resume states.

13. The device of claim 12 wherein the operations further comprise:
receiving a second wait point following initiating playback of the first media stream, and
suspending playback of the first media stream in accordance with the second wait point.

14. The device of claim 13 wherein the operations further comprise:
detecting completion of a second action associated with the second wait point; and ending suspension of the playback of the first media stream responsive to detection of the completion of the first action.

15. The device of claim 12 wherein the operations further comprise:
locally suspending playback by the first device;
refraining from sending update messages and ignoring update messages from other devices while the first device is locally suspended;
ending the local suspension; and
processing received update messages to update the playback and resume playback of the first media stream in accordance with the update messages.

16. The device of claim 12 wherein the first wait point is pre-scheduled, identified in a received status update, and identifies a specific point in the first media stream.

17. The device of claim 12 wherein the operations further comprise:
selecting a second wait point following initiating playback of the first media stream; and
communicating the second wait point to the other devices via a status update.

18. A device comprising:
a processor; and
a memory device coupled to the processor and having a program stored thereon for execution by the processor to perform operations to perform a method for controlling a first device to coordinate with other devices in suspending playback of a media stream, the operations comprising:
accessing first content, via the first device, to obtain a first media stream having a first wait point that identifies a first playback position in the first media stream and is associated with a first action;
initiating playback of the first media stream on the first device;
encountering the first playback position of the first media stream following initiating playback;
suspending playback of the first media stream on the first device at the first playback position in response to encountering the first playback position identified by the first wait point;
detecting completion of the first action by the first device;
broadcasting an update message representing a ready to resume state by the first device to other devices that are accessing the first content and playing respective media streams of the first content;
receiving update messages from the other devices representing one or more of the other devices have achieved ready to resume states; and
resuming playback of the first media stream at the first device in response to receiving a threshold number of update messages indicating that the other devices have achieved the ready to resume states.

19. The device of claim 18 wherein the operations further comprise:
receiving a second wait point following initiating playback of the first media stream; and
suspending playback of the first media stream in accordance with the second wait point.

20. The device of claim 12 wherein the operations further comprise:
locally suspending playback by the first device;
refraining from sending update messages and ignoring update messages from other devices while the first device is locally suspended;
ending the local suspension; and
processing received update messages to update the playback and resume playback of the first media stream in accordance with the update messages.
